(19) United States
(12) Patent Application Publication
(10) Pub. No.: US 2009/0294509 A1
(43) Pub. Date: Dec. 3, 2009

(54) METHOD AND APPARATUS FOR APPLYING CONVEYOR BELT LACING

(75) Inventor: Robert Yorke Pharr, Concord, NC (US)

Correspondence Address: ADAMS INTELLECTUAL PROPERTY LAW, P.A., Suite 2350 Charlotte Plaza, 201 South College Street, CHARLOTTE, NC, 28244, US

(73) Assignee: YORKE EQUIPMENT SOLUTIONS, LLC, Concord, NC (US)

(21) Appl. No.: 12/128,845

(22) Filed: May 29, 2008

(51) Int. Cl. B25C 7/00

(52) U.S. Cl. 227/155

(57) ABSTRACT

A press for attaching a fastener to belting. The press includes a support structure, an anvil, a punch and a clinching block. The anvil is fixedly positioned on the support structure. The punch and the clinching block are attached to the support structure such that they are movable between a first position and a second position. The clinching block is configured to engage a first fastener positioned between the clinching block and the anvil as the clinching block moves between the first position and the second position such that the fastener is clinched between the anvil and the clinching block. The punch is configured to engage a second fastener as the punch moves between the first position and the second position such that the second fastener is preclinched between the anvil and the punch.

### BACKGROUND OF THE INVENTION

This invention relates generally to a method and apparatus for attaching fastening means to an end of a belting material or web and more specifically to applying a clinched fastener to an end of a conveyor belt.

It is generally known to connect opposing ends of a webbing to form a loop for use as a conveyor belt. The opposing ends can be connected by welding or use of an adhesive or by mechanical fasteners. One type of mechanical fastener is known as “lacing” and is attached to a conveyor belt end by a clinched wire such as a brad or staple.

As used herein, the term “lacing” refers to fasteners configured to be attached to the ends of a web for joining two opposing ends of a conveyor belt together. Lacing is conventionally provided in the form of multiple lacing units that are connected together. By way of example and not limitation, one conventionally known lacing unit is generally u-shaped and includes a loop portion and two side walls configured to receive a staple. The staple is also generally u-shaped and has two generally parallel legs that extend away from a connecting piece. In use, a conveyor belt end is positioned between the two side walls of the lacing such that the loop portion extends away from the end of the belt. The legs of the staple extend through both side walls of the lacing and the conveyor belt such that the conveyor belt is retained between the side walls of the lacing unit. The connecting piece of the staple is position on the one side of the lacing and the staple legs are clinched on an opposite side of the lacing unit.

When multiple lacing units are attached to a first conveyor belt end, adjacent loops are separated by a gap, i.e., the loops are arranged in a “toothed” pattern. Each gap is configured to receive a corresponding loop from a second end. The first and second ends are positioned together such that their respective loops form a passageway for receiving a linking member such as a rod or pin. In this regard, the lacing attached to the first and second ends along with the linking member form a flexible seam joining the first and second conveyor belt ends.

One problem with conventional lacing is that the staple legs can not be pushed through the webbing and clinched in the same step. According to one known method for clinching the fastener, after a driving step in which the fastener is driven through the belt, the belt is turned over and positioned on an anvil such that a portion of the fastener extends away from the anvil. The fastener is then manually clinched using a hammer and punch. According to another known method, a clinching die must be substituted for a punching die after the driving step and before a clinching step.

### BRIEF SUMMARY OF THE INVENTION

Accordingly, there is a need for an apparatus and method for a driving a fastener through a conveyor belt and clinching a fastener without reconfiguring the apparatus.

Therefore it is an object of the present invention to provide a press for driving fasteners through webbing for a conveyor belt and for clinching the fasteners without turning the belt over or reconfiguring the press.

It is another object of the present invention to provide a press for driving a fastener through webbing for a conveyor belt and pre-clinching the fastener in one step.

It is another object of the present invention to provide a press for clinching a second fastener in the same step and for driving a first fastener through webbing for a conveyor belt.

Therefore there is provided a press for attaching a fastener to belting. The press includes a support structure, an anvil, a punch and a clinching block. The anvil is fixedly positioned on the support structure. The punch and the clinching block are attached to the support structure such that they are movable between a first position and a second position. The clinching block is configured to engage a first fastener positioned between the clinching block and the anvil as the clinching block moves between the first position and the second position such that the fastener is clinched between the anvil and the clinching block. The punch is configured to engage a second fastener as the punch moves between the first position and the second position such that the second fastener is preclinched between the anvil and the punch.

In accordance with a further embodiment of the invention, there is provided a method for attaching a fastener to a material such as conveyor belt webbing, comprising the following steps. A) providing a support structure; an anvil positioned on the support structure; a punch attached to the support structure such that the punch is movable between a first position and a second position; a clinching block positioned near the punch and movable with the punch; positioning a first fastener and an end of webbing such that the first fastener is between the punch and the anvil and the webbing is between the fastener and the anvil; B) moving the punch from the first position to the second position, wherein the following sub-steps are included; 1) driving the first fastener through the webbing; and 2) preclinching the first fastener; C) repositioning the first fastener and the end of webbing such that the first fastener is positioned between the clinching block and the anvil, and a second fastener is between the punch and the anvil; and D) moving the punch and the clinching block from the first position to the second position, wherein the following sub-steps are included; 1)driving the second fastener through the webbing; 2) preclinching the second fastener; and 3) clinching the first fastener.

### BRIEF DESCRIPTION OF THE DRAWINGS

The subject matter that is regarded as the invention may be best understood by reference to the following description taken in conjunction with the accompanying drawing figures in which:

FIG. 1 is perspective view with fragmentary enlargements of a press for applying lacing to conveyor belts according to one embodiment of the present invention;

FIG. 2 is a front view of the press shown in FIG. 1 showing the press in a first position;

FIG. 3 is a side view of the press shown in FIG. 2;

FIG. 4 is a front view of the press shown in FIG. 2 showing the press in a second position;

FIG. 5 is a top view of the press shown in FIG. 1;

FIG. 6 is an exploded perspective view of a portion of the press shown in FIG. 1;

FIG. 7 is a top view of an anvil according to one embodiment of the press shown in FIG. 1;

FIG. 8 is a side view of the anvil shown in FIG. 7; and

FIG. 9 shows lacing to be attached to webbing according to one embodiment of the present invention; and

FIG. 10 is a side view of the lacing shown in FIG. 9.

### DETAILED DESCRIPTION OF THE INVENTION

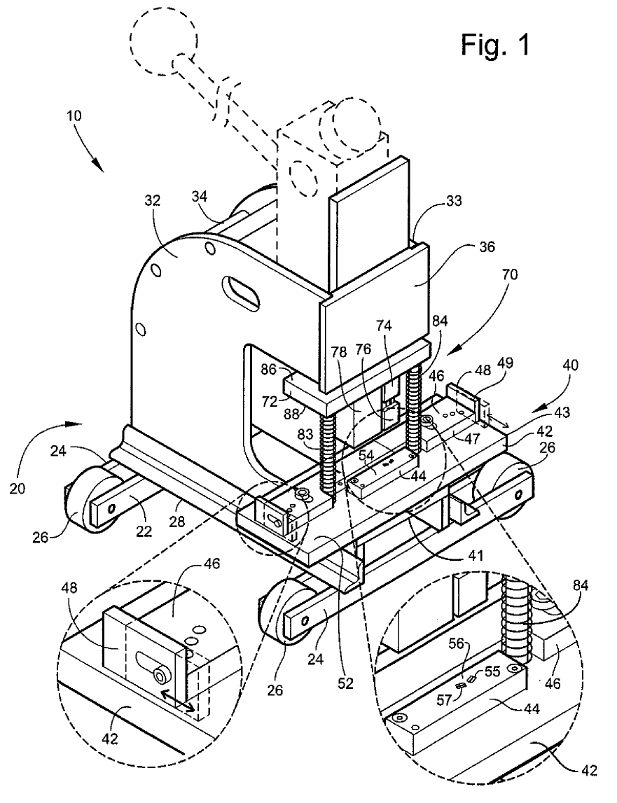

Referring to the drawings wherein identical reference numerals denote the same elements throughout the various views, FIG. 1 illustrates a press 10 according to the present invention. The press 10 is configured to attach lacing to an end of a web such as a conveyor belt. The press 10 includes a support structure 20, a bottom plate assembly 40, and a die assembly 70.

Referring now to FIG. 1, the support structure 20 includes a wheeled base 22 having two spaced-apart longitudinal members 24. Each longitudinal member 24 has a wheel 26 positioned at either end thereof such that the wheels 26 define a plane positioned to one side of the support structure 20. The longitudinal members 24 are connected by two cross members 28. Together the longitudinal members 24 and the cross members 28 are configured to support two spaced-apart side walls 32 and 33 that extend away from the plane defined by the wheels 26. In one embodiment, longitudinal members 24 are connected by side walls 32 and 33 and there are no cross members 28. In the illustrated embodiment, the two side walls 32, 33 are connected together by a plurality of reinforcing members 34, a front wall 36, and longitudinal members 24 and a mounting plate 41.

Continuing to refer to FIG. 1, the bottom plate assembly 40 is positioned on the mounting plate 41. A generally rectangular bottom plate 42, an anvil 44, a backstop 46, and two end gauges 48. The anvil 44 is generally rectangular and is positioned on a surface 52 of the bottom plate 42 and attached thereto by a conventionally known means such as threaded fasteners or welding. The anvil 44 defines a generally planar bearing surface 54. In the illustrated embodiment, a first pair 56 of indentations 55 and a second pair 57 of indentations 55 are formed in the anvil 44 such that the indentations 55 extend into the anvil 44 away from the bearing surface 54.

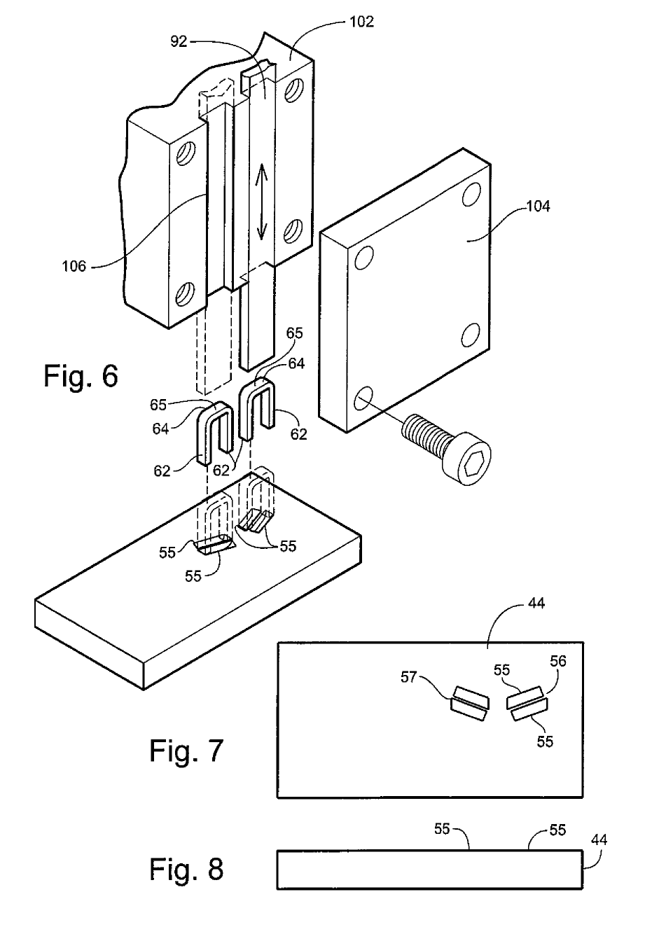

Referring now to FIGS. 6, 7, and 8, indentations 55 are configured to receive a fastener such as a leg 62 of a staple 64. Each indentation 55 is formed such that it is generally parallel to the corresponding indentation 55 and positioned at an angle to the staple 64 to deform the staple 64 such that it is pre-clinched when the press is operated as will be discussed further below.

As shown in FIG. 1, the backstop 46 defines a wall surface 47 that extends generally perpendicularly from the surface 52 of the bottom plate 42 and runs generally parallel to a line defined by the first and second pairs 56, 57 of indentations 55. In the embodiment shown, the backstop 46 is configured to be positioned at one of a first, second, or third predetermined distance from the indentations 55.

Referring now to the two end gauges 48, one is positioned at each end of the backstop 46. Each end gauge 48 defines a finger 49 and is movable between a first position in which the finger 49 extends beyond a plane defined by wall surface 47 toward a front edge 43 of the bottom plate 42 and a second position in which the finger 49 is positioned such that the plane defined by the wall surface 47 lies between the finger 49 and the front edge 43.

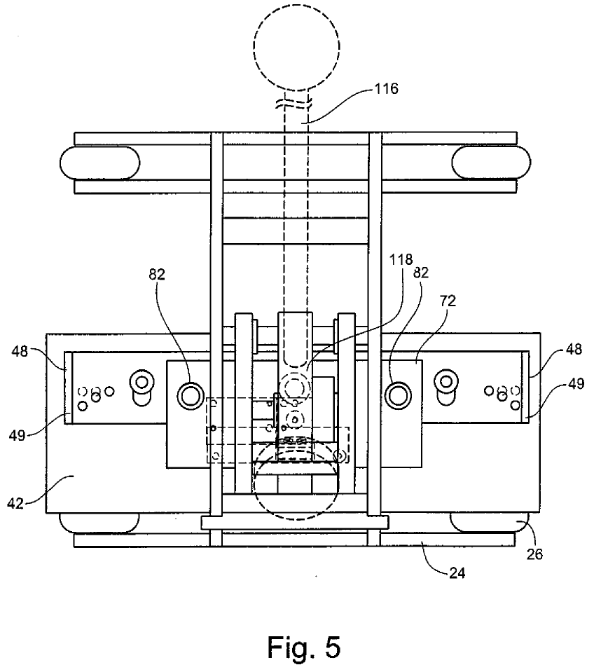

Referring now to FIGS. 1-5, the die assembly 70 includes an upper plate 72, a punch die 74, a punch guide die 76 and a clinching die 78. The die assembly 70 is movable between a raised first position, and a lowered second position. The upper plate 72 is generally rectangular and has two openings defined therethrough for receiving guide posts 83 and 84. The guide posts 83, 84 extend upward from bottom plate 42. The guide posts 83, 84 are positioned such that they are generally parallel to each other and perpendicular to the bottom plate 42. Springs 85 are positioned around posts 83 and 84. The upper plate 72 is positioned such that it is generally parallel to the bottom plate 42 and springs 83 and 84 are operable to bias upper plate 72 away from the bottom plate 42.

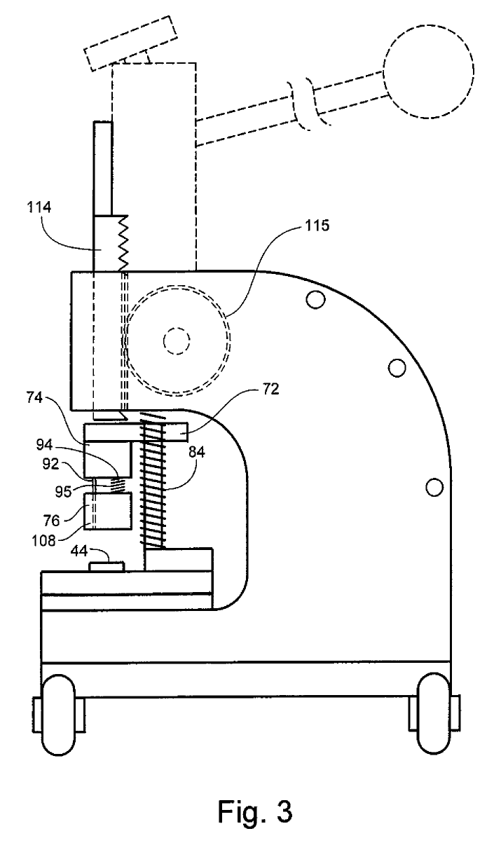

The upper plate 72 defines two main opposing sides, and upper side 86 and a lower side 88. The punch die 74 extends from the lower side 88 of the upper plate 72. In one embodiment, the punch die 74 has two punches 92 that extend therefrom such that the punches 92 are generally parallel to the guide posts 83, 84. Each punch 92 is aligned over one of pair 56, 57. A guide rod 94 as seen in FIG. 3 extends between punch die 74 and punch guide die 76, and a spring 95 is positioned around the guide rod 94. Spring 95 is operable to bias guide die 76 away from punch die 74.

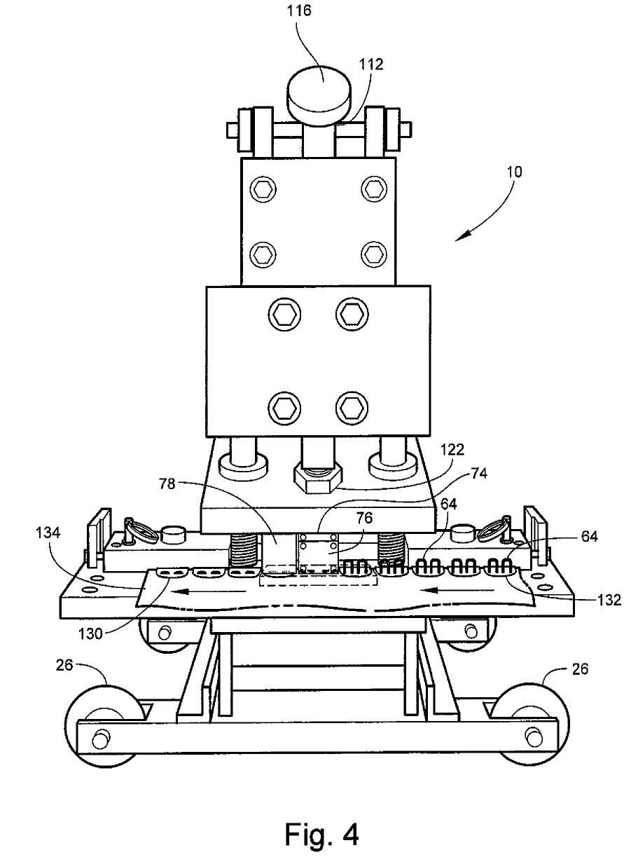

The punch guide die 76 is movable relative to the punch die 74 in conjunction with movement of the upper plate 72. In this regard, when the upper plate is in the first, raised position, the punch guide die 76 is spaced-apart from the punch die 74 by action of the spring 95 and when the upper plate 72 is in the second, lowered position, the punch guide die 76 directly contacts the punch die 74. It should be appreciated that in some embodiments, the guide die 76 does not directly contact the punch die 74 when the upper plate 72 is in the second, lowered position. When the upper plate 72 is in the raised first position, the punch guide die 76 is also spaced-apart from the anvil 44 such that portion of webbing and lacing can be received therebetween as shown in FIG. 4.

Referring to FIGS. 3 and 6, the punch guide die 76 includes a main body 102 and a cover 104. Two generally parallel grooves 106 are formed in the main body 102. The cover 104 and the grooves 106 define passageways 108 that are configured to receive the punches 92 such that they are movable therethrough and are operable to maintain the punches in alignment with the pairs 56, 57 of the indentations 55.

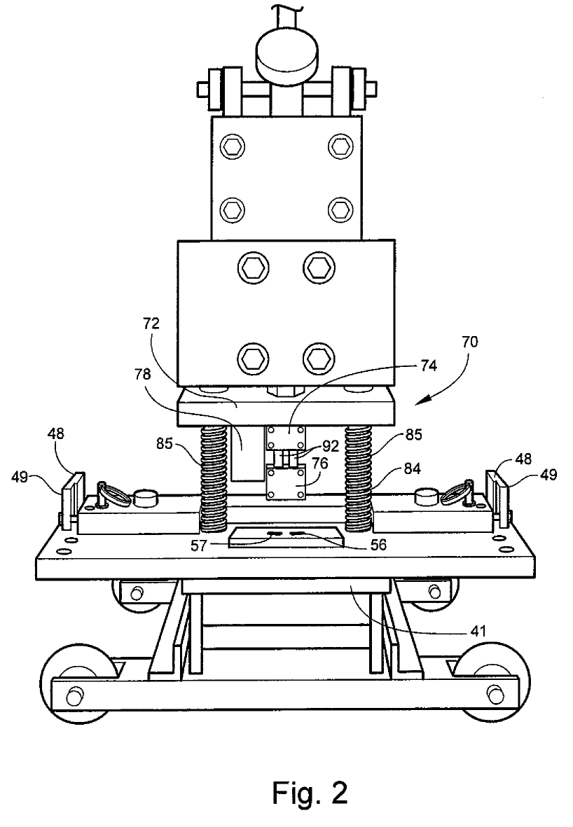

Referring now to FIGS. 2-4, the upper plate 72 is connected to an actuating mechanism 112 by a linkage 114. In the illustrated embodiment, the actuating mechanism 112 includes a handle 116 that extends away from a mechanical lever 118. Mechanical lever 118 is configured to transform motion of handle 116 to linear motion of the linkage 114. In this regard, linkage 114 is configured to transmit force to the upper plate 72 and cause movement of the die assembly. An adjustment mechanism 122 is configured such that the relative position of the upper plate 72 and the linkage 114 can be adjusted. In the illustrated embodiment, the adjustment mechanism 122 is a threaded connector that includes a threaded rod or bolt. In this regard, the position of the clinching block 78 and the punch guide die 76 relative to the anvil 44 when the upper plate is in the second, lowered position is determined by the adjustment mechanism 122.

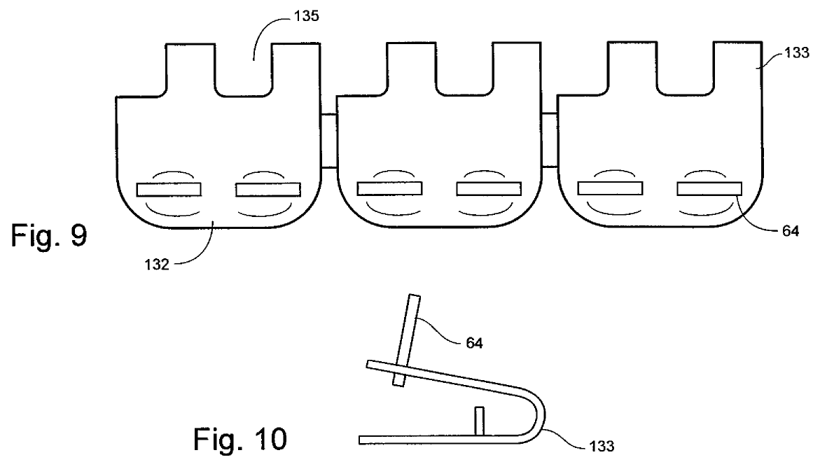

Referring now to FIGS. 1-4, the present invention can be better understood by way of a description of its operation. Generally the press 10 is operable to attach lacing unit 132 by driving and clenching the staples 64. First, a plurality of connected lacing units 132 are positioned such that end 134 of the webbing is received between the two sides of the lacing units 132 and loop portions 133 of the lacing units 132 extends away from end 134. The operation of press 10 can be described as a sequence of substantially similar sequential cycles during which a given lacing unit is exposed to a preclinching step and then to a clinching step. Between each cycle, the press 10 can be repositioned relative to the lacing units 132 by rolling the press 10 along the wheels 26. Alternatively, the lacing units 132 can be moved with the conveyor belt as the press 10 remains stationary. The lacing units 132 can be aligned with the press 10 by engaging the fingers 49 of the end guides 48 with the gaps defined by adjacent loops of adjacent lacing units 130 as shown in FIG. 9.

To further aid alignment of the lacing units, the backstop 46 is positioned in one of the first position, second position, or third position according to the dimensions of lacing unit 132. In this manner backstop 46 is adjustable such that press 10 can accommodate various sizes of lacing.

A cycle includes the following steps. In an alignment step, the loop portion 133 is positioned against backstop 46 such that staples 64 are aligned with passageways 108. In a prepositioning step, the handle 116 is moved to cause the die assembly 70 to move down from the first raised position such that the staples 64 are received within the passageway 108. It should be appreciated, that when using the powered embodiment of press 10 the step of prepositioning can be performed manually using the provided handle (not shown). In a driving step, the die assembly 70 is moved from the raised position to the lowered position by action of handle 116. For a first lacing unit 132, the driving step includes an engaging step, and a preclinching step. The punches 92 engage the staples 64 within the passageway 108 and cause the staples 64 to be driven down through the lacing unit 130 and the end 134. In the preclinching step, the ends of the staple legs of staples 64 engage indentations 55. As the die assembly continues to move toward the lowered position, the staple legs are guided by the indentations to fold over toward the opposite leg and to twist or bend such that the two staple legs do not contact each other. In this manner, the staple legs are “preclinched” and in position to be seated against the lacing unit 130 in a clinching step. As used herein, the term “clinched” refers to the state of having been secured by being driven sideways. As used herein, the term “preclinched” refers to the characteristic of having been driven sideways and subject to being driven further sideways. During the preclinching step, the bottom of the guide die 76 engages the lacing unit 130 positioned over the indentations 55 and causes the sides of the lacing unit to close in together to capture the end 134 of the conveyor belt. At the end of the driving step, the die assembly is in the lowered position. The staples 64 positioned over the anvil 44 and below the guide die 76 are positioned such that the staple legs extend through the end 134, a crosspiece 65 of the staple 64 engages one side of the lacing unit 130, and the staple legs are in a preclinched position on the other side of the lacing unit 130. Following completion of the driving step, the die assembly 70 is moved to the raised position by action of the handle 116.

After the first cycle described above, the lacing and the end of the conveyor belt is moved relative to the backstop 46 such that a second pair of staples 64 are aligned with passageways 108. In this position, the preclinched staples 64 are over the anvil 44 and below the clinching die 78. The steps indicated above are repeated in a second cycle. During the second cycle, the clinching die 78 engages the previously preclinched staples and further deforms them such that they are in a clinched position.

In an alternative embodiment, the actuation mechanism is hydraulically, pneumatically, or electrically powered. According to these embodiments, the actuator 112 is connected to the upper plate 72 through a rack and pinion system wherein the linkage 114 is configured as a rack. In this alternative embodiment, a handle 115 (shown in FIG. 3 in broken lines) is provided for manually adjusting the position of the linkage 114. Thus the handle is effective to manually adjust the positions of the punch die 74 and the punch guide die 76.

To summarize, by operation of the press 10, the staples associated with a first unit of conveyor belt lacing are clinched as staples associated with a second unit of conveyor belt lacing are preclinched. In the illustrated embodiment, the press 10 is portable and can be moved relative to a conveyor belt. In this regard, the press 10 is useful for repair and modification of existing conveyor belts. It should be appreciated that the present invention can be easily configured to attach other types of fasteners to conveyor belt ends where a staple, brad, nail, wire or the like is positioned through the conveyor belt and clinched such that the staple remains in position.

The foregoing has described a press 10 and a method for the use thereof for attaching lacing to a conveyor belt, wherein fasteners are driven through the belt and clinched in one step. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. A press for attaching a fastener to belting, the press comprising:
a support structure;
an anvil positioned on the support structure;
a punch attached to the support structure such that the punch is movable between a first position and a second position;
a clinching block positioned near the punch and movable with the punch; and
wherein the clinching block is configured to engage a first fastener positioned between the clinching block and the anvil as the clinching block moves between the first position and the second position such that the fastener is clinched and the punch is configured to engage a second fastener positioned between the punch and the anvil as the punch moves between the first position and the second position such that the fastener is preclinched.

2. A press according to claim 1, further comprising:
actuator that is movable between a first position and a second position and is operable to cause the punch to move.

3. A press according to claim 1, further comprising:
an indentation formed in the anvil and aligned with the punch such that the indentation is operable to capture an end of the fastener and to guide the end as the punch moves between the first and the second position.

4. A press according to claim 3, wherein the fastener is a staple having a first leg and a second leg and the anvil includes a first indentation and a second indentation that are each configured to guide the first leg and the second leg such that they are generally parallel when the punch is in the second position.

5. A press according to claim 1, further comprising a backstop for aligning the fastener with the anvil.

6. A press according to claim 5, wherein the back stop is movable between a first position and a second position.

7. A press according to claim 6, further comprising a finger positioned at an end of the backstop for further aligning the fastener with the anvil.

8. A press according to claim 3, further comprising multiple indentations arranged in cooperative pairs.

9. A method for attaching a fastener to a material such as conveyor belt webbing, comprising the steps of:
providing a support structure; an anvil positioned on the support structure; a punch attached to the support structure such that the punch is movable between a first position and a second position; a clinching block positioned near the punch and movable with the punch;
positioning a first fastener and an end of webbing such that the first fastener is between the punch and the anvil and the webbing is between the fastener and the anvil;
moving the punch from the first position to the second position, wherein the following steps are included;
driving the first fastener through the webbing; and
preclinching the first fastener;
repositioning the first fastener and the end of webbing such that the first fastener is positioned between the clinching block and the anvil, and a second fastener is between the punch and the anvil; and
moving the punch and the clinching block from the first position to the second position, wherein the following steps are included;
driving the second fastener through the webbing;
preclinching the second fastener; and
clinching the first fastener.

10. A method of attaching a fastener according to claim 9, wherein the fastener is a staple that is a component of a lacing unit.

11. A method of attaching a fastener according to claim 10, wherein the lacing unit is part of a plurality of attached lacing units, wherein each lacing unit includes a loop portion.

12. A method of attaching a fastener according to claim 10, further comprising the step of:
aligning the fastener with the anvil by abutting at least one loop portion against a backstop, wherein the backstop is aligned with the anvil.

13. A method of attaching a fastener according to claim 10, further comprising the step of:
aligning the fastener with the anvil by positioning the plurality of lacing units such that a finger positioned at an end of the backstop is between two adjacent loop portions.

14. A method of attaching a fastener according to claim 9, further comprising the step of providing a guide die having a passageway formed therein, the passageway being configured to receive and guide the punch as the punch moves between the first position and the second position.

15. A method of attaching a fastener according to claim 14, further comprising the steps of:
aligning the fastener with the passageway formed in the die guide;
moving the punch between the first position and the second position such that the die guide moves; and
receiving a portion of the fastener within the passageway.

16. A method of attaching a fastener according to claim 15, further comprising the step of pushing the fastener along the passageway with the punch.

17. A method of attaching a fastener according to claim 16, further comprising the step of pushing the fastener free from the passageway as the punch moves to the second position.
